(19) United States
(12) Patent Application Publication
(10) Pub. No.: US 2004/0261525 A1
(43) Pub. Date: Dec. 30, 2004

(54) Device for measuring the volume of fluid in a tank

(76) Inventor: Jack Chen, Oak Brook, IL (US)

Correspondence Address: Robert L. Marsh, P.O. Box 4468, Wheaton, IL, 60189-4468, US

(21) Appl. No.: 10/602,517

(22) Filed: Jun. 24, 2003

(51) Int. Cl. G01F 23/72; G01F 22/00

(52) U.S. Cl. 73/313; 73/314; 73/DIG. 5; 73/149

(57) ABSTRACT

A detector for detecting the volume of fuel in a fuel tank includes a float for floating on the surface of the fuel, a magnetically conductive member, a magnet, and a sensor for sensing the strength of a magnetic field. The field from the magnet passes through the magnetically conductive member and the sensor is positioned near an outer surface of the magnetically conductive member where it can detect a portion of the field passing through the magnetically conductive member. An arm connects the float to one of the magnetically conductive member and the sensor for moving the one relative to the other. The shape of the magnetically conductive member is a function of the volume of fuel in the tank and the strength of the portion of the magnetic field detected by the sensor is proportional to the fuel in the tank. An output from the sensor controls an indicator that provides a measurement of the fuel in the tank.

### BACKGROUND OF THE INVENTION

The desirability of measuring the fuel level and/or fuel volume in a fuel tank in a number of different environments is apparent. Typically, the fuel level and/or fuel volume is measured by use of a float connected by an arm to the wiper of a variable resistor. The float moves with the level of the fuel and the float moves the arm causing the wiper to move along an arcuate wiper track. The resistance of the resistor varies along the wiper track in accordance with the fuel level and/or volume of fuel in the fuel tank.

The use of a variable resistor has certain drawbacks. The electrical contacts of such devices are subject to corrosion when the device is used to measure the amount of a corrosive fuel such as methanol. Such fuels will cause corrosion of the contacts for resistor, capacitor, ultrasonic or optical measuring devices. Corrosion of the contact points causes inaccuracies in the measurements taken.

It would be desirable to have a fuel sensor that measures fuel level and/or fuel volume in a fuel tank for which the contacts do not corrode in the presence of corrosive fuel such as methanol. Such a sensor would preferably provide accurate measurements at an economical cost so as to be an economic substitute for prior art fuel sensors.

### SUMMARY OF THE INVENTION

Briefly, the present invention relates to a device for measuring the volume of liquid in a container, where the device includes a float moveable in response to changes in the volume of the liquid and a magnetically conductive member having a magnetic field passing therethrough and emanating out of a surface thereof. The invention further includes a device for sensing the strength of a portion of the magnetic field and for generating a signal in response to the strength of the portion of the field being measured. The sensor is position near, but space from, the outer surface of the magnetic member.

The invention further includes means connected to the float for moving one of the magnetically conductive member and the sensor relative to the other wherein the sensor is positioned to measure the magnetic field emitted from different portions of the surface of the magnetically conductive member in response to changes in the volume of the liquid in the container. The strength of the field detected by the detector is altered in responses to changes in the volume in the container by changing the distance between the outer surface of the magnetically conductive member and the detector, or by providing variations in the thickness of the magnetically conductive member. A greater amount of magnetic flux is directed through the thicker portions of the magnetically conductive member than through thinner portions to thereby alter the density of flux being measured by the sensor.

The sensor generates an electric signal which, in the preferred embodiment, is linearly related to the strength of the magnetic field being detected thereby. The sensor is connected into a circuit with a power source and a display, wherein the output from the sensor is indicated on the display as a volume of liquid in the container.

In a first embodiment of the invention, the magnetically conductive member is a magnet with one of the poles thereof positioned along the surface. In a second embodiment, the magnetically conductive member is not magnetized, but is positioned between the ends of a magnetic flux conducting circuit. A magnet in the circuit generates a magnetic field which is then directed by the circuit through the magnetically conductive member and through the sensor spaced from the outer surface thereof. The movement of either the magnetically conductive member or the sensor with respect to the surface thereof causes changes in the density of the flux measured by the sensor.

The strength of the magnetic field in the proximity of the sensor is varied in response to variations in the volume of liquid, such as a fuel, in the tank. Since the present invention does not incorporate elements requiring electrical contacts in the proximity of the liquid, such as a wiper and a wiper track, the elements of the invention will not be deteriorated when used to measure the volume of corrosive liquid.

### BRIEF DESCRIPTION OF THE DRAWINGS

A better understanding of the present invention will be had after a reading of the following detailed description taken in conjunction with the drawings, wherein:

FIG. 1 is a schematic of a fuel tank and a fuel detector made in accordance of the principles of the present invention;

FIG. 2 is a schematic of the fuel detector shown in the fuel tank of FIG. 1;

FIG. 3 is a front elevational view of the magnetically conductive element shown in FIG. 2;

FIG. 4 is a cross-sectional view of the magnetically conductive element shown in of FIG. 3 taken through line 4-4 in FIG. 3;

FIG. 5 is an isometric view showing the inner parts of the fuel detector shown in FIG. 2;

FIG. 6 is an isometric view of the inner parts of a second embodiment of a fuel detector in accordance with the invention; and

FIG. 7 is a cross sectional view of a fuel tank and a fuel detector in accordance with a third embodiment of the invention.

### DETAILED DESCRIPTION OF A PREFERRED EMBODIMENT

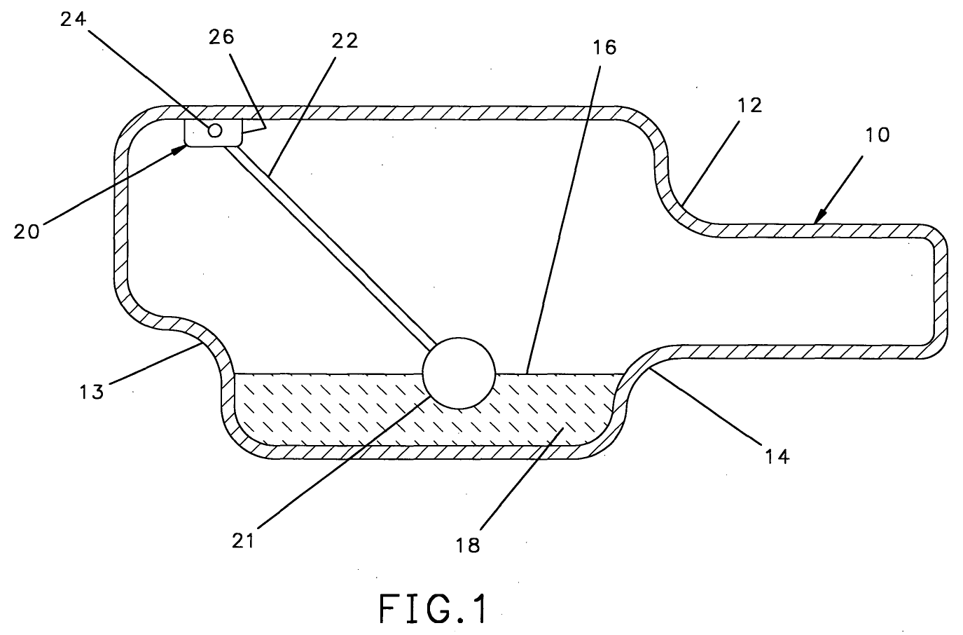

Referring to FIG. 1, a fuel tank 10 in a vehicle is irregular in shape to fit within the confines of the space available in the vehicle and has a plurality of indentations 12, 13, and 14 therein, and therefore, the volume of liquid in the tank is not proportionate to the depth of the surface level 16 of the liquid fuel 18. A detector 20 for detecting the volume of the fuel 18 within the tank 10 includes a float 21 mounted on a rod 22 one end of which pivots about a pin 24 in a housing 26 mounted within the tank 10.

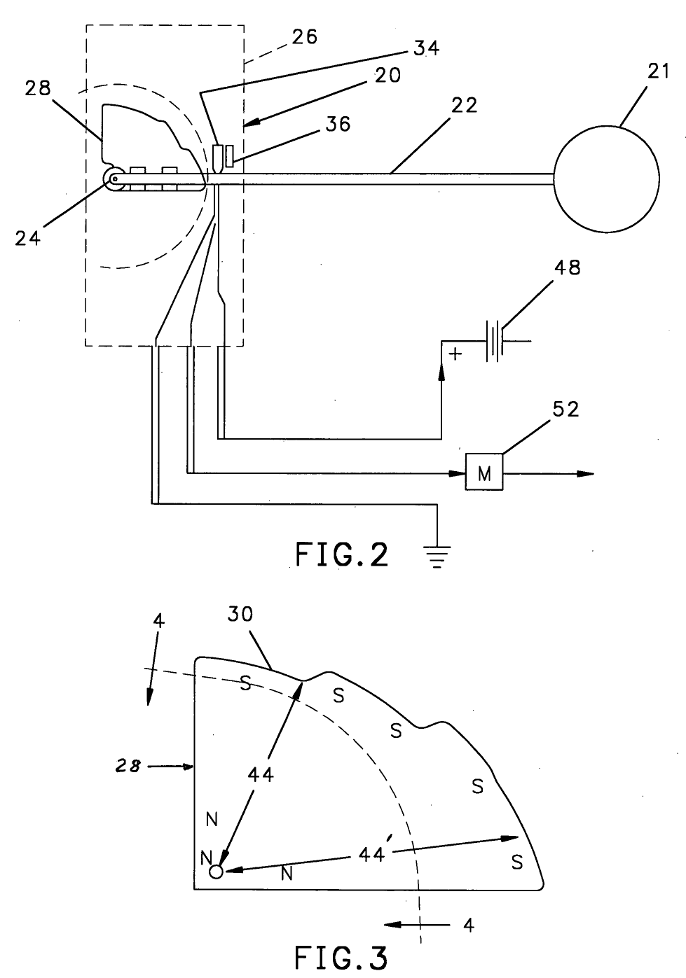

Referring to FIGS. 2 through 5, within the housing 26 and connected for rotation with the rod 22 about the pin 24 is an irregularly shaped magnetically conductive member 28. In the first embodiment of the invention, the magnetically conductive member 28 is a permanent magnet having a north pole N and a south pole S. In this embodiment, the magnetically conductive member 28 has one pole S positioned adjacent the pivot pin 24 and the second pole N positioned along the surface 30 that is most distant from the pivot pin 24. The various points on the outer surface 30 define varying radial distances 44, 44′ from the pivot pin 24 as is further described below.

Positioned in the housing 26 radially outward of the outer surface 30 of the magnetically conductive member 28 is a sensor 34 for sensing the strength of a magnetic field such as a Hall-Effect sensor of the type known in the art. Preferably, the sensor 34 provides an output signal that is linearly proportionate to the magnetic strength of the field being detected.

Radially outward of the sensor 34 is an outer end 36 of a U-shaped flux concentrator 38. The flux concentrator 38 has a second end 40 positioned near the pivot pin 24 and a central member 42 extending between the first and second ends 38, 40 completing a flux circuit and through which magnetic flux of the magnetic field 43 generated by the permanent magnet of the magnetically conductive member 28 can flow. The flux concentrator 38 maximizes the portion of the magnetic flux emanating from the outer surface 30 adjacent the sensor 34 and directs that portion of the magnetic flux through the sensor 34 such that the sensor 34 can measure the strength thereof.

As best shown in FIG. 3 through 5, the shape of the magnetically conductive member 28 is irregular, and most importantly, the outer surface 30 thereof is generally arcuate, although the radii 44, 44′, defined by the distance between the pivot pin 24 and the various points that make up the surface 30, are not equal. Accordingly, as changes in the volume of fuel 18 in the tank 10 causes movement of the float 24 and rotation of the rod 22 about the pivot pin 24, the distance 45 between the nearest point on the outer surface 30 and the sensor 34 changes, thereby causing changes in the amount of flux measured by the sensor 34.

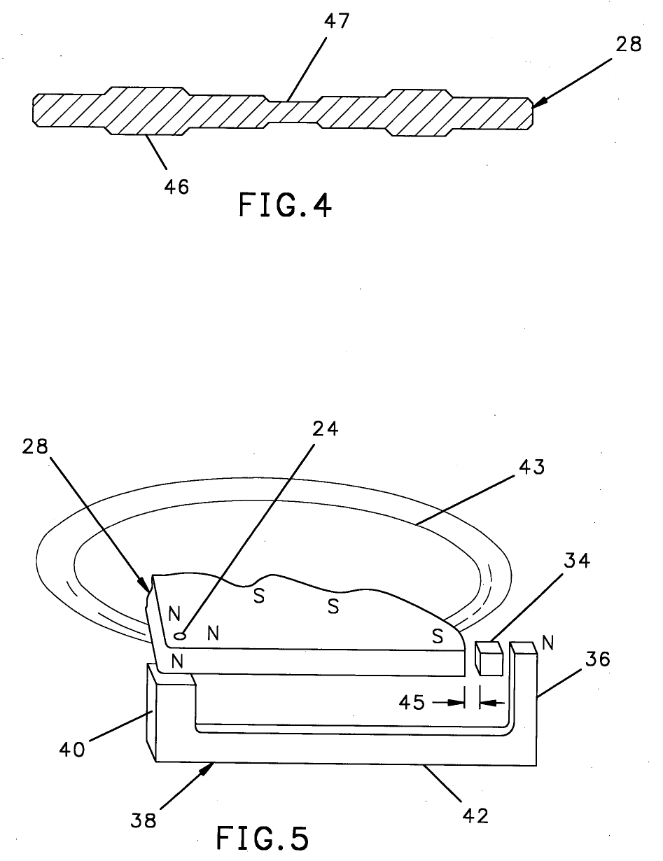

As best shown in FIG. 4, the thickness of the magnetically conductive member 28 also is not a constant, but has at least one relatively thick portion 46 and a relatively thinner portion 47 with the thick portion 46 forming a wider portion of the outer surface 30 than the thinner portion 47. The portion of the outer surface 30 adjacent the thicker portion 46, emits a greater concentration of flux than does the portion of the outer surface 30 adjacent the thinner portion 47.

The shape of the magnetically conductive member 28, including the proportioning of the thickness 46, 47 thereof and the radii 44, 44′ to the points on the outer surface 30 thereof, is a function of the volume of liquid fuel in the tank 10. The portion of the magnetic field emanating from the outer surface 30 that is detected by the sensor 34 varies in response to changes in the volume of fuel 18 in the tank 10 causing a corresponding angular rotation of the magnetically conductive member 28 about the pivot pin 24. In accordance with the invention, the variations in the thickness 46, 47 and the variations in the radii 44, 44′ to the various positions of the outer surface 30 of the magnetically conductive member 28 are configured to generate a field of magnetic flux that is a function of the volume of the fuel 18 within the tank 10, and the portion of the field measured by the sensor 34 is proportional to the fuel in the tank 10.

As shown in FIG. 2, the sensor 34 is incorporated into a circuit with a power source 48 to generate an electrical output that is directed to an indicator 52 mounted on the dashboard of a vehicle, not shown. The indicator 52 responds to the signal generated by the sensor 34 to provide a readout of the volume of liquid fuel 18 in the tank 10.

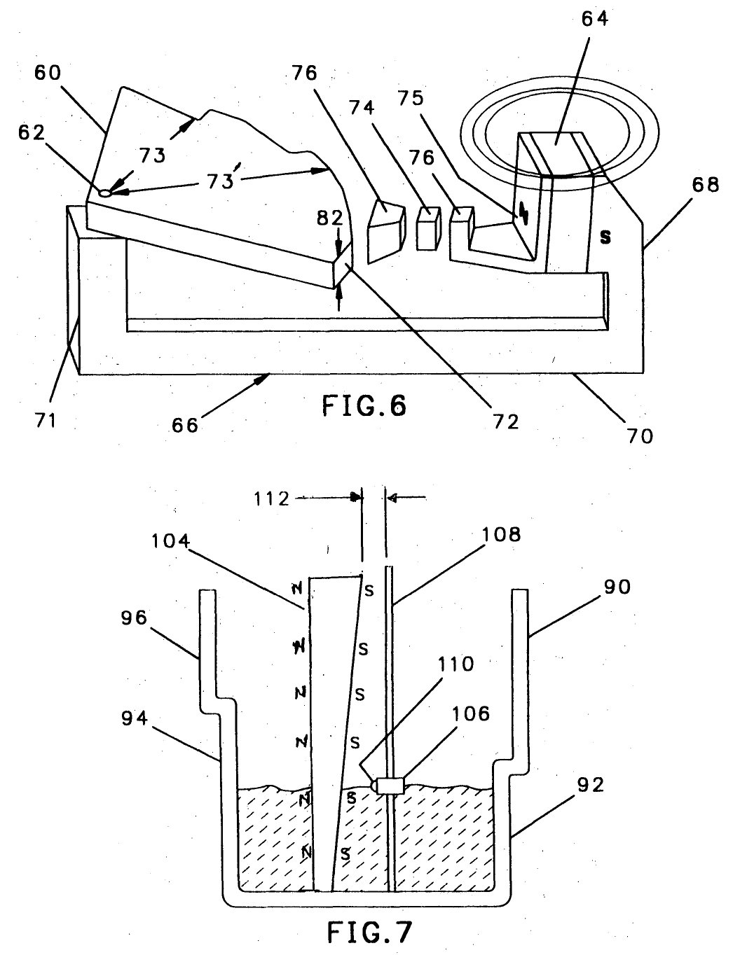

Referring to FIG. 6, in another embodiment of the invention 56, an irregularly shaped magnetically conductive member 60 in accordance with the invention is mounted for rotation about a pivot pin 62 in response to movement of a float and rod, similar to the float 24 and rod 22 described above. In this embodiment, the member 60 is magnetically conductive, but none of the material thereof bears magnetization.

Spaced from the magnetically conductive member 60 is a permanent magnet 64 having north and south poles N, S respectively and generating a field of magnetic flux. The magnetic flux from magnet 64 is directed through a magnetically conductive circuit 66 consisting of a first leg 68 one end of which rests against one pole S of magnet 64 with the opposite end of leg 68 connected to an elongate transfer plate 70 that is in turn connected to one end of a second leg 71. The opposite end of the second leg 71 is adjacent the magnetically conductive member 60 and near the pivot pin 62.

The magnetically conductive member 60 has an outer surface 72 which generally scribes an arc but the various points on the surface 72 are not all equidistant from the pivot pin 62; the points on the surface 72 being at various different radii 73, 73′ from pivot pin 62. Mounted on the housing, not shown, for the device 56 and spaced outward of the outer surface 72 is a sensor 74, such as a Hall-effect sensor, for sensing the field strength of a portion of the magnetic field.

The second pole N of the magnet 64 has a flux plate 75 mounted thereon through which magnetic flux is directed to a flux emission surface 76 positioned near the sensor 74 and opposite the surface 72. In this embodiment, a small magnetically conductible segment 76 is positioned between the surface 72 of the magnetically conductive member 60 and the sensor 76 for concentrating flux through the sensor 74.

Like the magnetically conductive member 28 of the first embodiment, the magnetically conductive member 60 has an irregular shape with variable radii 73, 73′ in which the points on the outer surface 72 are spaced from the pivot pin 62. Similarly, the thickness 82 of the magnetically conductive member 60 is not constant, but varies to enhance or constrict the magnet flux flowing therethrough.

By virtue of the varying thickness 82 of the magnetically conductive member 60 and the varying the radii 73, 73′ to the outer surface 72, the amount of magnetic flux that is emanates from the nearest portion of the outer surface 72 of the magnetically conductive member 60 and passes through the segment 76 and sensor 74 varies with changes in the level of the liquid 18 in the tank 10. The magnetically conductive member 60 is therefore configured such that the flux being measured by the sensor 74 is a function of the volume of the liquid fuel 18 in the tank 10. The sensor 74 is positioned in a circuit like that described with respect to the sensor 34 with the electrical output from the sensor 74 operating an indicator, not shown, to indicate the volume of the liquid fuel 18 within the tank 10.

Thus, there is no contact point between the magnetically conductive member 28, 60 and the associated sensors 34, 74 which can corrode in the presence of corrosive fuel. As the level of fuel increases or decreases, the magnetic sensors 34, 74 are exposed to a different portion of the magnetically conductive member 28, 60. The sensors 34, 74 sense the strength of the magnetic field and creates a voltage output based on this strength.

Referring now to FIG. 7 in yet another embodiment of a device made in accordance with the present invention, a fuel tank 90 has three different cross-sectional areas 92, 94, 96 at each of three different heights as shown. In this embodiment, the magnetically conductive member is a generally vertically oriented bar 104 with a pole N along one side thereof and a second pole S along the other side thereof. The bar 104 extends vertically within the tank 90 and is made of a non-magnetic, non-corrosive material such as ferrite.

A float 106 is vertically moveable along a float rod 108 extending into the tank 90 and generally parallel to the bar 104. Fixed to the float 106 is a sensor 110 for measuring the strength of the adjacent portion or the magnetic field formed by the magnetic bar 104. As with the other embodiments, the magnetic sensor is preferably a linear Hall-Effect sensor that generates a voltage in proportion to the strength of the magnetic field being detected. The relative strength of the magnetic bar 104 is varied by varying the distance 112 between the magnet 104 from the magnetic sensor 110. As the volume of the fuel tank 112 increases, the distance 112 between the magnet 104 and the magnetic sensor 110 decreases, thus creating a stronger magnetic field. Alternately, the thickness of the magnetic bar 104 can be varied as a function of volume.

While in the preferred embodiments described herein both the thickness of the magnetically conductive member and the spacing from the sensor are varied, the device can be constructed with one of the two variables held as a constant. Thus, a constant thickness magnetically conductive member can be used with a variable spacing of the member from the sensor. Similarly, a constant spacing from the sensor can be used with a variable thickness of the magnetically conductive member.

It should be understood that various changes in the modifications to the preferred embodiments described herein will be apparent to those skilled in the art. Such changes and modifications can be made without departing from the spirit and scope of the present invention and without diminishing the present invention's intended advantages. It is therefore intended that such changes and modifications be covered by the appended claims.

1. A device for measuring the volume of liquid in a container, said device comprising,
a float moveable in response to changes in the volume of said liquid in said container,
a magnetically conductive member having a north pole, a south pole, a magnetic field passing therethrough, and an axis defined by said north and said south poles,
said magnetically conductive member having a contoured shape and a thickness perpendicular to said axis that varies across said contoured shape wherein a greater magnetic field passes through thicker portions of said contour than thinner portions thereof,
a sensor for sensing the strength of a portion of said magnetic field and for generating a signal responsive to said strength,
said sensor positioned in said magnetic field and spaced from said magnetically conductive member, and
means connected to said float for moving one of said magnetically conductive member and said sensor relative to the other of said magnetically conductive member and said sensor wherein said signal generated by said sensor is a function of said volume of said liquid in said container.

2. The device of claim 1 wherein the relationship between a level of said liquid in said container to the volume of said liquid is not linear.

3. The device of claim 1 and further comprising means responsive to said signal for displaying the volume of liquid in said container.

4. The device of claim 1 wherein the spacing between said magnetically conductive member and said sensor changes in response to movement of said float.

5. The device of claim 1 wherein said magnetically conductive member is a magnet.

6. The device of claim 1 and further comprising
a magnet remote from said magnetically conductive member, and
a flux concentrator for directing flux of a magnetic field through said magnetically conductive member and across said sensor.

7. The device of claim 1 wherein the strength of said magnetic field passing through said magnetically conductive member is stronger through some portions thereof than through other portions thereof.

8. (canceled)

9. The device of claim 1 wherein said sensor is a Hall-Effect sensor.

10. The device of claim 1 further wherein the device is a fuel gauge.

11. The device of claim 1 further wherein the liquid is fuel.

12. The device of claim 11 further wherein the fuel includes methanol.

13. (canceled)

14. (canceled)

15. The device of claim 14 further wherein the Hall-Effect sensor is linear.

16. (canceled)

17. (canceled)

18. The device of claim 13 further including an electronic device that receives the electronic output of the magnetic sensor and indicates that volume of the fuel in the container.

19. (canceled)

20. (canceled)

21. (canceled)

22. (canceled)

23. (canceled)

24. A device for measuring the volume of liquid in a container, said device comprising,
a float moveable in response to changes in the volume of said liquid in said container,
a magnetically conductive member having a magnetic field passing therethrough,
said magnetically conductive member having a contoured shape and a thickness perpendicular to a direction of magnetic flux emanating from said conductive member, said thickness varying across said contoured shape wherein a greater magnetic field passes through thicker portions of said contour than thinner portions thereof,
a sensor for sensing the strength of a portion of said magnetic field and for generating a signal responsive to said strength,
said sensor positioned in said magnetic field and spaced from said magnetically conductive member, and
means connected to said float for moving one of said magnetically conductive members and said sensor relative to the other of said magnetically conductive member and said sensor wherein said signal generated by said sensor is a function of said volume of said liquid in said container.
